(19) United States
(12) Patent Application Publication
(10) Pub. No.: US 2002/0194105 A1
(43) Pub. Date: Dec. 19, 2002

(54) Process of and system for trading securities and options and markets related thereto

(76) Inventor: Andrew Klein, Ocean, NJ (US)

Correspondence Address: FURGANG & ADWAR, 1140 Avenue of the Americas, 15th Floor, New York, NY, 10036, US

(21) Appl. No.: 09/861,445

(22) Filed: May 18, 2001

(51) Int. Cl. G06F 17/60

(52) U.S. Cl. 705/37

(57) ABSTRACT

Disclosed is a method for computerized trading of options in which the number of contracts and the “bid and ask” data are displayed in a succession of windows maintained by an “electronic book.” Each window is open for 20 seconds. In the first 5 seconds after a window has closed, a specialist has exclusive access to the window to place trades and publish the executed trade data. After that, traders and brokerage agencies have access to the new window to place trades. The general public has access to the window to observe the trading process. All trades are made on a real time basis and in the order, by time, in which they are received by the electronic book. Trades are limited to a predetermined range within each window so as to maintain a stable and orderly market.

### BACKGROUND OF THE INVENTION

1. Field of the Invention

The present invention relates to a method of trading securities and options on stock market indices and equities, as well as an improved options market as a result thereof.

2. Description of the Related Art

Options, as a means of hedging risk, are of increasing interest not just to speculators and small investors or traders (hereafter jointly and severally referred to as “traders”), but also to those whose revenue depends heavily upon the floating price of a commodity in the marketplace such as insurance and mortgage companies, banks, credit unions, farmers and other commodity producers, such as mining companies, oil companies, and manufacturing companies. Insurance companies hedge against a change in the yield curve, or the cost of money over different time horizons. Banks and credit unions protect themselves from unanticipated loan prepayments if interest rates fall precipitously. Commodity producers, which have a significant investment and lead time from production to market, hedge against an unanticipated drop in prices. Manufacturers of all types from electronics to cereals, can protect themselves from an increase in the price of key production items, such as gold or oats.

The present invention provides a unique system for trading options on underlying indexes and equities which are bought and sold on regulated exchanges around the world. “Options,” “equities” or “securities” are used interchangeably throughout the terms. Ownership of a “call” option gives the purchaser the right, but not the obligation, to buy a particular security at an established price (the “strike price” or the “exercise price”). Ownership of a “put” option gives the purchaser the right, but not the obligation, to sell a particular security (called the underlying security) at the strike price. The sellers of both the put and the call are obligated to perform the transaction if demanded by the purchaser of the option. This performance is guaranteed by the posting of a performance bond (the “margin requirement”). The purchaser of the option may exercise the option (i.e., choose to buy/sell at the strike price) at any point prior to the expiration of the life of the option. If exercise is possible, the option is said to be “in-the-money” or “intrinsic,” otherwise it is “out-of-the-money” or “extrinsic.” The expiration dates of exchange-traded options are standardized and the same option contract may be bought or sold at any point prior to expiration. A trader who purchases an option (put or call) is said to be “long” the option and holding a “long call” or “long put.” A trader who sells an option (put or call) is said to be “short” the option and holding a “short call” or “short put.”

A significant factor in measuring the efficiency of the current option price system or, for that matter, the purchase of any security, is the difference (or “spread”) between the “bid” price (the price a member of the public can get when selling an option or security) and “ask” price (the price, which is higher, the member of the public will pay to purchase the option or security) for the option or security.

The published price of the “bid” and “ask” is generally established by a “specialist” or “market maker.” Some investigative reports have suggested that the published bid/ask spread is often wider than the true spread. (See, “Price-fixing, the Amex way,” Business Week, Apr. 26, 1999, p. 99 et seq.) The “market maker” may often be able to establish a narrower spread. Large traders, as opposed to small individual traders, can take advantage of this narrower spread thereby gaining an unequal advantage over the small trader.

In the options markets, in particular, there are numerous time-related delays which adversely affect the trader. It is believed that one common disadvantage with the present system is that marketplaces fail to report in a timely and accurate fashion execution and cancellation reports, accurate current quotes and sizes, any indication of the current standing of limit orders on the book, and any publication of market depth above and below the bid/ask spread. The effect of delay and the failure to provide accurate and timely information has caused many in the investing community to lose confidence in the markets.

Also, approximately one hundred options may be listed for the Chicago Board Options Exchange's S&P 500 index options market with various expiration dates and strike prices. This number of options provides a diverse range of products, but also has the effect of keeping traders split between and among the options and helps guarantee thin markets and wide quotation spreads. This is to the benefit of the specialist or market maker and, conversely, makes trading for incremental profits an extremely difficult proposition for traders. As reported in the above-referenced Business Week article, it is estimated that the average spread between the bid and the ask on options is often 10% or greater. It is believed similar spreads are to be found in the Chicago Board of Exchange (the “CBOE”).

The collected prior art does not teach a system or process for resolving the disparity created between the bid and asked as disclosed in the Business Week exposé. Thus, for example, Doughtery, III, in U.S. Pat. No. 5,884,286, entitled Apparatus and Process for Executing an Expirationless Option Transaction discloses a computer system for receiving and storing data on a particular asset. The computer then generates data representative of an expiration list option premium for use in transacting an option which does not expire.

Likewise, Cristofich et al., in U.S. Pat. No. 5,671,363, entitled Private Stock Option Account Control and Exercise System discloses a data processing system for managing stock option accounts for a plurality of participants. Each plan, in terms of grant, invest, and an expiration date, is defined by the sponsoring company. The data processing system then implements the designated plan for multiple clients.

So, too, Doughtery, III, in U.S. Pat. No. 5,557,517, entitled System and Method for Determining the Process of an Expirationless American Option and Issuing a Buy or Sell Ticket on the Current Price and Portfolios, discloses a system and method for determining the price of an expirationless American option over a broad variety of securities. The system issues the correct bid and ask price for the option.

None of these patents disclose a method or process for narrowing the spread between bid and asked to make a more efficient marketplace.

### BRIEF SUMMARY OF THE INVENTION

It is an object of this invention to provide a marketplace for options on stock market indices, equities, and securities in which the trading range is limited within discreet predetermined amounts.

It is another object of this invention to provide practically instant access to a marketplace accessible to a specialist, floor brokers, brokerage houses and investors and traders on a real time basis.

It is yet another object of this invention to provide a marketplace which limits trading within predetermined periods of time.

It is an object of this invention to provide a marketplace that will limit the range of the bid/offer spread and guarantee market depth.

It is still a further object of this invention to provide a marketplace which may limit risk for buyer, seller, and specialist and yield higher profits.

In accordance with the teachings of this invention there is provided a method of trading securities of the type in which traders, brokerage agencies, and specialists take part. This method comprises receiving, storing, displaying, and transmitting data; displaying data of the bid and ask for securities within a defined predetermined and accessible location for a predetermined period of time; matching the “marketable” orders for the securities to facilitate the execution of sales of the securities; closing access to the location after the predetermined period of time; opening access for a predetermined period of time after the closing; and displaying in the opened accessible location data representative of a number of securities and the prices asked and/or bid therefor.

In yet another aspect of this invention there is provided a method of trading securities of the type in which traders, brokerage agencies, and specialists obtain information from computers linked to other computers through a global network. The method includes providing a market-based computing means and receiving, storing, displaying, and transmitting data by the market-based computing means. The method further includes displaying data of the bid and ask for securities within a defined predetermined window displayable by the market-based computing means for a predetermined period of time and matching by the market-based computing means the bid and asked prices for the securities to facilitate the execution of sales of the securities. The method also includes closing access to the window by the market-based computing means upon expiration of the predetermined period of time and opening access to the next window by the market-based computing means for a predetermined period of time upon the closing of the first window, as well as displaying by the market-based computing means in the opened accessible window data representative of a number of securities and the prices asked and/or bid therefor.

In still another aspect of this invention there is provided a method of security trading of the type using computers linked in a global network, such as the Internet which comprises providing a market-based computer and linking, by means of the global network, the market-based computer to others who have computers. It further includes providing predetermined portions of the data as a function of the roll played by those linking to the market-based computer and limiting access to the entire data by means of recipient-specific access codes.

### BRIEF DESCRIPTION OF THE SEVERAL VIEWS OF THE DRAWING

FIG. 1 is a flow diagram in accordance with the invention.

### DETAILED DESCRIPTION OF THE INVENTION

This invention is directed to a system and method of trading options or other securities over a predetermined period. This system and method, is generally referred to as a “Weekly Options Market,” is believed to be the first to offer fully inter-active trading and take advantage of the economies and convenience of the Internet but may also be used in other communications environments.

In accordance with this invention, limit and market orders may be compiled on an electronic book and displayed on a screen similar to the one currently in use on the New York Stock Exchange for equities, an example of which is:

Current Marketable Order Imbalance: NONE

| | | | | | buy | |
|---|---|---|---|---|---|---|
| all-or-none | sell stop | | | | stop | all-or-none |
| bids | orders | BID | PRICE | OFFER | orders | offers |
| 50 | 17 | 167 | 1.75 | | | |
| | | 50 | 1.80 | | | |
| 25 | | 62 | 1.85 | | | |
| | 20 | 150 | 1.90 | | | |
| | | 200 | 1.95 | | | |
| | | | 2.00 | 150 | | |
| | | | 2.05 | 96 | | 100 |
| | | | 2.10 | 10 | 28 | |
| | | | 2.15 | 100 | 50 | 75 |
| | | | 2.20 | 212 | | |

The type of information provided to the trader in the “window” is diagrammatically shown above. Under PRICE are the price levels of the current BID and OFFER (e.g., $1.95 BID for 200 contracts, with 150 contracts OFFERed at $2.00) as well as the BIDs and OFFERs within the next four price levels. Numbers directly to the left of PRICE levels represent contracts BID for, and directly to the right of PRICE levels are the contracts OFFERed at those levels. Numbers in the “all-or-none bids,” “sell stop orders,” “buy stop orders,” and “all-or-none offers” columns represent contracts of that type at the corresponding PRICE levels. The “Current Marketable Order Imbalance” for this window is currently indicated as “none.”

The electronic book may be organized so that all orders are presented in an easily understood format and, in that format, disseminated to all market professionals and the public simultaneously. Information in this book is fed to a data base maintained by the Market for dissemination to market viewers of the Internet websites. Thus, the display may provide bids and offers “at the market,” within several levels above and below the last sale, as well as all sales that take place. Entries may be made in the book at the trading desk manually or by any electronic means such as a PDA or similar means well known in the art.

Specific data pertaining to a particular trader's account (such as “contracts ahead,” executions, cancellations, and limit changes) may be instantly confirmed on that trader's computer.

The Weekly Options Market may be operated in accordance with the following procedures. The entered orders may be displayed in a screen or alternate window. Trading may take place in these ‘windows’. Each window, as it appears sequentially, may be accessible by investors through a website which is also linked to their brokerage account.

A window may be open for a predetermined amount of time, all marketable orders entered within that predetermined time frame may be executed in a “flash fill” in time precedent sequence of sellers trading to the bid limit and buyers trading to the offer limit in the time order that they were entered. It is believed that 20 seconds may be an adequate time to have each window opened for trading. Any excess supply or demand that is not satisfied by the specialist or his/her designation to floor brokers is carried over to the next window, and that market information is immediately disseminated, including “contracts ahead” reports for all carried orders. (A “carried order” is an order that was “marketable” going into the previous window, but not completely filled in that window. “Marketable” means either a market order to buy or a limit order to buy that is willing to pay at or above what was the current offer, or a market order to sell or a limit order to sell that was offered at or below the current bid.)

Each window displays a predetermined number of levels above and below the last trade. Preferably, five such levels above and below the last sale are displayed in each window.

All trading takes place in cash accounts, with orders entered by the brokerage firm where the customer maintains his/her option account. Each brokerage firm will monitor the position of their traders. Capital requirements, as set by the SEC or other governing body, will be the responsibility of each brokerage firm for their customers as in current options accounts. In all cases, the trader's brokerage firm shall be ultimately responsible to cover obligations on any options written by their traders.

Any excess orders that are not executed due to completion of the bid or offer are paired at the offer if buyers exceed sellers and at the bid if sellers exceed buyers with the imbalance offered to the specialist. The specialist then has the choice to buy at the previous bid for excess sellers or to sell at the previous offer for excess buyers, or allocate those imbalances to floor brokers or their orders. If the specialist neither buys nor sells the imbalance, the orders are held over to the next window. However, in no case are these orders considered “stopped,” or guaranteed at any predetermined minimum or maximum price.

No more than two execution prices trade in any single window. All carry over orders have time precedence into the next window. Between windows, all new orders are entered, changed, or canceled, provided they are not needed to fill carried over orders. Orders that attempted to cancel on the opposite side of a current order imbalance will have a “cancel pending” status if they are possibly mathematically necessary to fill that imbalance. An order with this “cancel pending” status would be canceled only after the imbalance that existed at the time the cancellation request was received has been filled, regardless of whether it could be used to offset an imbalance created thereafter. Then, in the next window, the trading sequence executes again.

When the collection of orders in a window has closed, the window is then displayed to the specialist. In the time of this exclusive access in the current window, and as orders begin to gather for the next window, the specialist determines what his/her own participation may be in the current window out of all the possible trading sequences. The specialist is provided with exclusive access for a predetermined period of time which is preferably five seconds of the next 20 second window. In other words, during the specialists exclusive access, the specialist makes a decision and posts the execution within the five second window. The system then unlocks the window and all of the orders that have accumulated within the current window, which includes the specialists participation in the first five seconds of the window, will be executed or displayed in the continuation of that window.

Member broker participation may be allowed with time of entry determining the position on the electronic book for all market and limit orders entered prior to the current window's close so as to participate in the current trading window. All-or-none, stop and stop limit orders may be accepted. Fill-or-kill orders will not be accepted. There may be no matching the bid or offer, which would adversely affect customers with orders on the book.

In all but the fastest moving market conditions, each sale may be within $0.05 of the preceding sale, with at least 10 contracts traded per level, assured by the specialists participation. There may be no “tick” restrictions placed on the trader on any buy or sell order.

The specialist may be required to print at least 10 contracts at every $0.05 interval (on options trading at $5.00 or less, and $0.10 increment on higher priced options) in rising or falling markets. (A $0.05 moves in these options corresponds with a 0.5 point move in the S&P 500 indices for options on the S&P 500 Index.)

The specialist can only enter orders to buy on straight plus ticks or sell on straight minus ticks to unwind and not to add to his/her positions. This eliminates his/her ability to “front run” the market and benefit from his/her advantage of instant access, giving the public assurance of no self-dealing.

The specialist can trade for his/her own account by purchasing on minus, zero minus, and zero plus ticks and selling on plus, zero, and zero minus ticks and selling on plus, zero plus, and zero minus ticks. Any order the specialist chooses to enter competes with the traders and broker firms according to the aforementioned price and time entry parameters.

The electronic book automatically matches marketable orders and offers the specialist a quantity of option contracts to buy or sell at all possible price levels, at which point he chooses his/her level of participation. For example, in a window requiring two execution price levels and a last sale of two dollars ($2.00), there is a maximum of six possible trade sequences: 1) $1.95 and $1.90, 2) $2.00 and $1.95, 3) $2.00 and $2.05, 4) $2.05 and $2.10, 5) $1.95, and $2.00, or 6) $2.05 and $2.00. The second price to print becomes the new last sale. The electronic book may track the specialist's position for his/her information only and will automatically adjust the position of any limit orders he has on the electronic book according to the following condition. The specialists limit orders maintain standing when entered to offset (i.e., liquidate or cover) a position, and fall behind all traders and Member brokers' orders when his/her position has been offset. The electronic book automatically tracks the specialists position and will adjust the standing of his/her bids or offers once the specialist's position begins to offset. In other words, the specialist cannot maintain standings on the electronic book to add to his/her position.

To protect the specialist, and inhibit market manipulation, the specialists trading activity is never indicated to the public. The specialist may be compensated with a reasonable commission structure to enhance his/her profitability in consideration of the extra participation required and the limitations on trading strategy.

In very fast market conditions in the S&P 500 Weekly Options Market, based on predetermined premiums or discounts in the S&P 500 futures market, the parameters may be modified to allow options below $5.00 to move $0.10 per trading level, or twenty cents $0.20 per window. This special situation will allow the specialist to handle a move in the S&P 500 of 2 points per 20 second window or six points per minute (approximately 50 Dow points).

Should markets be moving in one direction faster than this pace, imbalances may accumulate and move, tick by tick, to the next equilibrium level. This slowing of the price movement process acts to decrease volatility and allows more time for imbalance dissemination and subsequent price improvement by participants.

As with all options, there are four types of executions that can be made in either the Weekly Options Market Put or Call.

Buying the Option “long”: An option may be “bought” to open a position. The option then can later be “sold” to close the position or held until expiration, whereby an option in the money will settle at a closing price rounded down to the corresponding twentieth of a point. This investment requires limited capitalization of only the contract value plus fees.

Selling the Option “short” (also known as “writing” the option): The option is “sold” (shorted) to open a position, with the proceeds credited to the “writer” of the option's account. The option can later be “bought” (to cover) to close the position or held until contract expiration when the writer is responsible for restitution of the closing price on an option in the money.

Options that expire with no value free the writer of this obligation, except for paying the settlement fee. This investment will require capitalization in excess of the opening contract value plus fees. How much in excess may be determined by the requirements of the S.E.C.

Using the example window above, if a buyer wishes to buy 500 contracts up to $2.15, with a last sale of $2.00, the following occurs: The order is time stamped. Any other buy order entered afterwards will fall behind this order. In each window the specialist will choose the best trading levels of the choices had under the guidelines. In the first window, the buyer buys everything at $2.00 (at least 150 contracts), then the buyer will buy every contract at $2.05 (at least 96 contracts plus the 100 offered all-or-none) plus any sellers entered. At this point, the buy imbalance may be disseminated along with a new bid/ask of $2.00 bid for 154 contracts (the remaining buy imbalance) and 10 offered at $2.10. In the next window, the buyer will buy everything that is available up to $2.10 and then the remaining 144 contracts at $2.15, sold by the book (100 contracts) and the specialist, possible using some of the all-or-none offers.

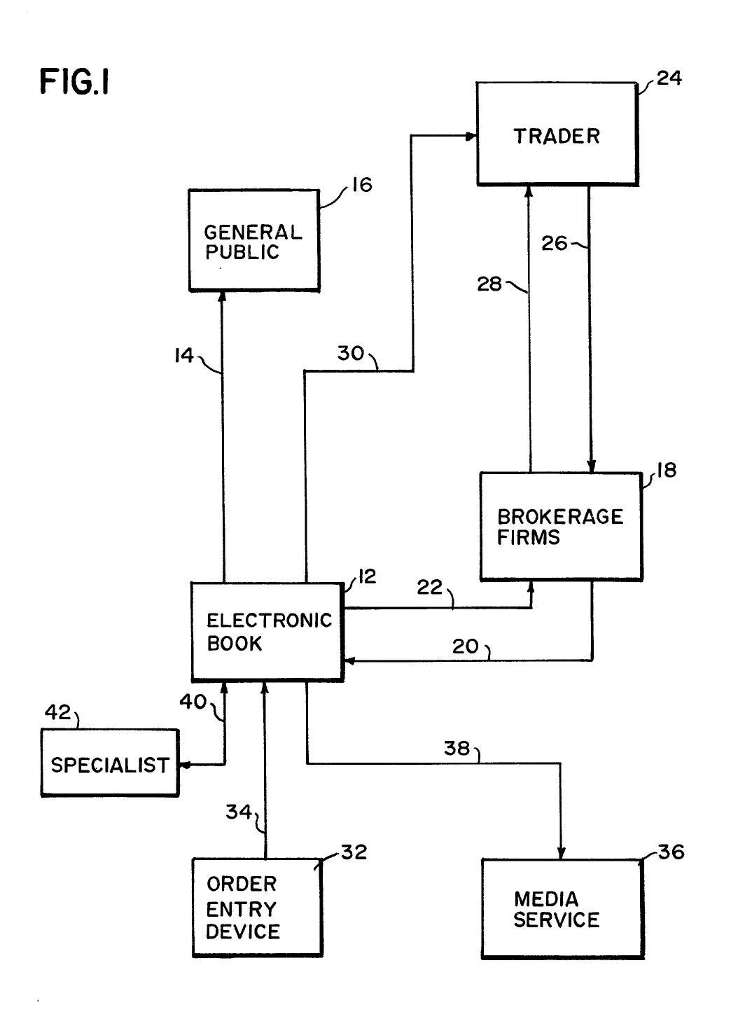

Turning to the drawing, a flow diagram (FIG. 1) of the overall system 10. A website 12 is maintained which displays the electronic book at the trading post on the floor of the listing exchange. This website 12 may be accessed 14 by anyone with a computer 16, including those without established brokerage accounts. The website 12 may provide any and all generalized market data, such as quotes and sizes at multiple price levels, all trading information, relevant index averages and charts, as well as other “market friendly” data. There may also be links to associated websites, such as the home pages of participating electronic access brokerage firms.

Brokerage firm computers 18 delivers data 20 to the “electronic book” 12 on the trading floor, such as order entry and cancellation as well as any other data necessary so that the electronic book links each order to its originating trader for instant execution and standing status information in a manner well known in the art. Access by the brokerage firm computer 18 to the book computer 12 may be by limited-access codes (as is well known in the art) barring other brokerage firms computers, trader computers 24, or the general public computers 16 from gaining access.

The electronic book computer website 12 delivers data 22 from the trading floor to brokerage firm computers 18, including all relevant order status information. That data will also be access limited to specific computers who have a need to receive such information.

Traders with accounts with brokerage houses may use their computers 24 to deliver 26 order entry and cancellation to their own electronic access-limited accounts at brokerage firm computers 18. These order entry and cancellations may be relayed by the brokerage firm to the trading floor in the usual manner. Alternatively, the brokerage firm computer 18 may transmit such data 20 to the electronic book computer or website 12.

The brokerage firm 18 may deliver 28 execution confirmations, trading account balances, and other data to the trader's computer 24. This data is also access limited to the communication between these computers.

The electronic book computer 12 delivers 30 execution reports, cancellation confirmations, and “contracts ahead” directly to any trader's computer 24 providing entered orders through their electronic access brokerage firm's computer 18. This may include pay services, possibly billed through the brokerage firm, such as licensed product data from the S&P 500 Futures Market. Such transmissions are access limited codes to specific traders by means well known in the art.

Order entry devices 32 on the trading floor may be used to transmit data 34 of orders and cancellations to the electronic book computer 12 entered by member brokers on the trading floor. Alternatively, such data may be entered by access limited codes and use any other means well known in the art, such as by key entry or similar means as is well known in the art.

The electronic book computer 12 also delivers market data 36 to news dissemination services and the provider of market update toll-free phone hot line 38. This data may be updated at predetermined intervals, preferably three times every minute. This changing data information is publicly available to the computers 16 of members of the general public but need not provide the ancillary information also provided to the public.

The specialist either manually or through an electronic order means 38 may receive and transmit 40 orders to the electronic book 12. Such transmissions may be made by access limited codes to that specialist, as is well known in the art. This access permits the specialist to trade during exclusive periods of each window and, also, when the window is open to all traders and brokerage firms.

The operation of the Weekly Options Market mandates that at the end of the predetermined period of time, preferably one week (as the name implies), the close of the market on that Friday determines the identical strike prices for both the put and call for the opening of the market the following Monday. Both of these options may be right near the market. Thus, when the Monday (or the next business day) morning opening, both options may be only a few ticks away from being in the money, depending on which way the market opens and starts to move.

In operation, the options on the S&P 500 Index may be as follows: The S&P 500 Index Weekly Call Option and its sister Put Option will open for trading on Monday morning with an identical strike price, which is preferably derived from the Friday closing cash value of the S&P 500 Index, divided by 10 and rounded to the nearest whole number (e.g., an S&P 500 index close of 1366.75 would produce the strike price of 137.00 for the next week's option). This coincides with the calculation used in determining the value of the AMEX's SPYders (approximately 1/10 of the S&P 500 index). These options will expire after the close of the last trading day of the week, usually Friday, with the index's closing value determining the value of one option “in the money”. (e.g., if the S&P 500 index rose to a 1412.63 [or 141.26 close, the call would have a value of $4.25 to those who held until settlement; the put would have no value.]) Market depth means the number of contracts which must be traded at each contiguous price level. Preferably, at least 10 contracts must be satisfied at each level in each trading window. This requirement imposes an obligation on the specialist. The specialist fulfills the obligation of maintaining the market. For example, if the window has a $1.90 bid for 5 contracts with 20 offered at $2.00 and there is no one else in the market except for the specialist, the specialist must bid for 10 contracts (5 for himself/herself). If the specialist had to bid $1.90 for all 10 contracts, he/she would be required to make a $1,900.00 investment to support the bid—a minimal investment. With the specialist guaranteeing the market depth, the effect is a tight bid/offer spread which also acts to limit volatility.

Another requirement of the Weekly Options Market is that the specialist guarantees a bid and offer, each within $0.05 of the last sale, and a maximum of $0.10 between them.

These requirements, along with the timed window parameters, help protect the public traders from the volatility of the market.

In operation, a single contract size may be one hundred times the option price (opening at about $200.00 in the S P 500 example) making it affordable to all traders. These options may be priced at 1/50 of the value of comparable CBOE options (which are ten times greater in price, based on the full four figure value of the S&P 500, with a single contract costing 500 times the option price). This price differential will provide much greater accessibility, liquidity, open interest, and volume.

Trading in the Weekly Options Markets may increase the chances of making incremental profits over the course of a day. The trader shall have a much better chance than in current markets where one must overcome a 10% or greater spread in the CBOE or AMEX options markets. In other words, under the Weekly Options Market, the trader can be just a little bit right and nevertheless show a profit because the premium paid on the way in and on the way out of the market is small.

The Weekly Options Market provides an interactive and practically instantaneous relationship between the trader's computer and a single specialist's trading post. The specialist follows the strict guidelines to limit volatility in the option's price, allowing the price to move only by the minimum $0.05 increments. Under this system and process it is preferred that the specialist maintain a maximum of a $0.10 spread between the bid and ask in all but the most volatile market situations. In many cases, market imbalances may be displayed for price improvement participation by traders viewing the activity on the web page and by broker participation on the trading floor. Every participant in this market receives real time information simultaneously as well as information specific to one's own account activity.

The principles of the Weekly Index Options Markets process and system may be used in existing and such additional markets as: sector indices, broader market and global indices. This invention also may include an options market for a constantly updated list of the previous week's most active equities. The flexibility of an option market that settles and re-opens fifty two times a year provides unlimited potential for traders. The ability to disseminate information instantly through an Internet website and/or news services as to what services may be offered for the upcoming week may be determined within minutes of the Friday close. The expense associated with, for example, these week-to-week changes is believed to be minimal, and the excitement created by the ability for the public to gain access to a reliable and equitable options markets for the most active sectors would be maximized.

Alternatively, trading could theoretically begin at any time after the Friday close, with Globex futures and foreign market performances influencing around-the-clock trading. It is preferable, however, that a more standard Monday through Friday, 9:00 a.m to 4:30 p.m. EST session be used initially.

Unlike other markets, the Weekly Options Market is efficiently priced in every window. Before the specialist is given the opportunity to make a profit on large disparities between the BID and ASK on large marketable imbalances, the information shall be disseminated for all participants and anybody who wants to improve the price can get in. Once the buy order is clocked and locked in, nobody else can buy until the first-in-time buy order is satisfied. In other words, any buyers that come in after the first-in-time buyer are now behind him/her. As the option starts creeping up to $2.05, $2.10, $2.15, $2.20, that buyer is still buying everything that comes in. This order of fixed preference is a major difference between the old system and the Weekly Options Market system.

Any bid, any offer, or any market order that has not been executed can be canceled. In other words, if a buyer put in an order to buy 500 contracts up to $2.15, and after the first window the buyer buys the 150 at $2.00, and then buys 96 at $2.05, now going to the next window the buyer still has 356 contracts to buy. If the buyer changes his/her mind, he can enter a cancel order. The order will be canceled provided in the next window, the window that the cancellation is received, no sellers has entered the market that can be executed against the buyer's bid. The reason for this is that the buyer's information has already been disseminated. It would not be fair for a buyer to show the public that he is willing to pay $2.15 and then withdraw against an impending seller who probably used that information as a basis to enter his/her order.

The trade sequence in each window does not show what a buyer is ultimately willing to pay. This “masking” of the limit enables the buyer to get the best possible prices.

If, on the other hand, a seller wishes to sell 500 contracts down to $1.80, then the same thing happens. In the current window, it will trade the two price levels. If the last sale is $2.00, it will trade 200 contracts at $1.95 and 150 contracts at $1.90, and it will be $1.85 BID for 62 contracts with 150 contracts OFFERed at $1.95 (the balance of the sell imbalance). In the next window it will trade 87 contracts at $1.85 and probably the last 62 at $1.80.

The only time market imbalance disappears from the screen is when the market gets down to a price where the imbalance's limit restrict it from selling any lower. Thus, if a seller has an order in to sell as low as $1.80, and all of the bids have been exhausted down to $1.80, and the seller has options for sale, the next window is going to show a $1.75 BID for 167 contracts. Whatever is left at $1.80 will be OFFERed at $1.80. Traders in the market will see this and they will be able to deduce that the market order had a $1.80 low and that market order will sell no lower. At this point the order may be published as a limit order. In the next window, buyers may jump in to pay $1.80 because they realize that the saleable market order is now gone, it is now OFFERed at $1.80. Buyers make their decision from there. Every order is listed as a market order as long as it is marketable in the current window. When the order gets to a window where the contracts are no longer marketable, then they are displayed as a limit order.

From the above description it will thus be seen that there has been provided new and novel system and method for a securities marketplace; which market is relatively simple in operation and is efficient in operation and fair to all participants.

It is understood that although there has been shown and described preferred embodiments of the invention that various modifications may be made in the details thereof without departing from the spirit as comprehended by the following claims.

In the claims:

1. The method of trading of, for example, securities and options of the type in which traders, brokerage agencies, and specialists take part, comprising:
a) receiving, storing, displaying, and transmitting data;
b) displaying data of the bid and ask for securities within a defined predetermined and accessible location for a predetermined period of time;
c) matching the bid and asked prices for the securities to facilitate the execution of sales of the securities;
d) closing access to the location upon expiration of the predetermined period of time;
e) opening access to the next location for a predetermined period of time upon the closing of the first location, and
f) displaying in the opened accessible location data representative of a number of securities and the prices asked and/or bid therefor.

2. The method recited in claim 1 further comprises closing the market on a predetermined day to determine the strike price at the opening of the market.

3. The method as recited in claim 2 the step of matching comprises filing orders (bid and ask) within each open location in time order of when received by the market.

4. The method as recited in claim 3 wherein the step of matching comprises carrying the excess supply or demand over to the next sequential open location.

5. The method as recited in claim 4 wherein the step of matching further comprises pairing any excess orders that are not executed in any open location due to completion at the offer (if buyers exceed sellers) and at the bid (if sellers exceed buyers).

6. The method as recited in claim 5 further comprises limiting each sale within a predetermined amount of money of the preceding sale.

7. The method as recited in claim 6 further comprises in the step of completing providing order collection in a location; providing exclusive access to the specialist for a predetermined period of time; collecting orders; limiting the period of exclusive access to less than the total predetermined time the location is open.

8. The method as recited in claim 7 further comprises providing the specialist with the choice to buy or allocate at the previous bid for excess sellers or to sell or allocate at the previous offer for excess buyers.

9. The method as recited in claim 8 further comprises in the step of matching, holding over the imbalance of all buys or sells to the next location if the specialist cannot satisfy the buys or sells.

10. The method as recited in claim 9 further comprises limiting executions to no more than two price levels in any single location, known as the bid level and offer level.

11. The method as recited in claim 10 further comprises entering, changing, or cancelling all new orders between the closing and opening of locations, provided such orders are not needed to fill carry over orders.

12. The method as recited in claim 11 further comprises accepting all-or-none, stop and stop limit orders.

13. The method as recited in claim 12 further comprises barring fill-or-kill orders and matching the bid or offer.

14. The method as recited in claim 13 further comprises barring any “tick’ restrictions placed on the traders on any buy or sell.

15. The method as recited in claim 14 further comprises requiring the specialist to print a predetermined amount of contracts at predetermined interval in rising or falling markets.

16. The method as recited in claim 15 further comprises restricting the specialist to enter orders to buy on straight plus ticks or sell on straight minus ticks to unwind and not add to the specialist's positions.

17. The method as recited in claim 16 further comprises permitting the specialist to trade for the specialist's own account by the specialist's purchasing on minus, zero minus, and zero plus ticks and selling on plus, zero, plus and zero minus ticks.

18. The method as recited in claim 17 further comprises requiring the specialist's orders to compete with traders and brokerage firms according to time of entry and price.

19. The method as recited in claim 18 further comprises matching automatically marketable orders and offering the specialist a quantity of option contracts to buy or sell at all possible price levels.

20. The method as recited in claim 19 further comprises permitting the specialist to chose the specialist's level of participation in the market.

21. The method as recited in claim 20 further comprises tracking the specialist's position and providing such position to the specialist only.

22. The method as recited in claim 21 further comprises adjusting automatically the position of the specialist in an open location to maintain the specialist's standing when either the specialist's limit orders are entered to offset (i.e., liquidate or cover) a position, or fall behind all traders and brokerage firms orders when the specialist's position has been offset.

23. The method as recited in claim 22 further comprises tracking the specialist's position and adjusting the standing of the specialists bids or offers once the specialist's position begins to offset thereby preventing the specialist from maintaining standings in the location so as to add to specialist's position.

24. The method as recited in claim 23 further comprises requiring the specialist to purchase a predetermined amount of contracts to maintain the depth of the market.

25. The method as recited in claim 24 further comprises requiring the specialist to guarantee the price range between two contiguous trading locations at twice the predetermined trading range to be traded in one of the windows.

26. The method as recited in claim 25 further comprises requiring that market imbalances disappear from the location when the market gets down to a price where it can no longer sell any lower, or high enough that a limited buy imbalance can pay no higher.

27. The method as recited in claim 2 further comprises closing the market on the last business day of a week and after the close of the major markets (e.g., NYSE, AMEX).

28. The method as recited in claim 26 further comprises closing the market on the last business day of a week and after the close of the major markets (e.g., NYSE, AMEX).

29. The method as recited in claim 1 wherein the predetermined period of opening of the location is approximately twenty seconds.

30. The method as recited in claim 7 wherein the opening period of the location is approximately twenty seconds.

31. The method as recited in claim 30 wherein the accessing by the specialist for an exclusive period of time comprises allocating the first five seconds after the close of the first location and within the opening of the next location so that the access takes place at the beginning of the next location.

32. The method as recited in claim 1 wherein making the location accessible to a specialist, traders, and brokerage firms.

33. The method as recited in claim 7 wherein making the location accessible to a specialist, traders, and brokerage firms.

34. The method as recited in claim 26 wherein making the location accessible to a specialist, traders, and brokerage firms.

35. The method as recited in claim 15 wherein the step of limiting the difference in the prior sales is $0.05.

36. The method of trading securities of the type in which traders, brokerage agencies, and specialists obtain information from computers linked to other computers through a global network comprising:
a) providing a market-based computing means;
b) receiving, storing, displaying, and transmitting data by the market-based computing means;
c) displaying data of the bid and ask for securities within a defined predetermined window displayable by the market-based computing means for a predetermined period of time;
d) matching by the market-based computing means the bid and asked prices for the securities to facilitate the execution of sales of the securities;
d) closing access to the window by the market-based computing means upon expiration of the predetermined period of time;
e) opening access to the next window by the market-based computing means for a predetermined period of time upon the closing of the first window, and
f) displaying by the market-based computing means in the opened accessible window data representative of a number of securities and the prices asked and/or bid therefor.

37. The method recited in claim 36 further comprises closing the market by the market-based computing means on a predetermined day; using the prices at the close of the market on the predetermined day to settle open contracts and to determine the strike price at the opening of the market on the next predetermined day.

38. The method as recited in claim 37 the step of matching comprises filing orders (bid and ask) within each open window in time order of when received by the market-based computing means.

39. The method as recited in claim 38 wherein the step of matching comprises carrying the excess supply or demand the market-based computing means over to the next sequential window opened by the market-based computing means.

40. The method as recited in claim 39 wherein the step of matching further comprises pairing the market-based computing means any excess orders that are not executed in any open window due to completion at the offer (if buyers exceed sellers) and at the bid (if sellers exceed buyers) by the market-based computing means.

41. The method as recited in claim 40 further comprises limiting by the market-based computing means each sale within a predetermined amount of money of the preceding sale.

42. The method as recited in claim 41 further comprises by the market-based computing means, closing the collection of orders in the window and first providing exclusive access to the specialist for a predetermined period of time which exclusive period being less than the total predetermined time the window is open.

43. The method as recited in claim 42 further comprises providing by the market-based computing means the specialist with the choice to buy at the bid level for excess sellers or to sell at the offer for excess buyers.

44. The method as recited in claim 43 further comprises in the step of matching, holding over all excess buys and sells to the next window if the specialist chooses not to fill the imbalances.

45. The method as recited in claim 44 further comprises limiting executions to no more than two contiguous price levels in any single window.

46. The method as recited in claim 45 further comprises the market-based computing means entering, changing, or cancelling all new orders between the closing and opening of windows, provided such orders are not needed to fill carry over orders.

47. The method as recited in claim 46 further comprises accepting all-or-none, stop and stop limit orders by the market-based computing means.

48. The method as recited in claim 47 further comprises barring fill-or-kill orders and matching the bid or offer by the market-based computing means.

49. The method as recited in claim 48 further comprises barring any “tick” restrictions placed on the traders on any buy or sell by the market-based computing means.

50. The method as recited in claim 49 further comprises requiring, by the market-based computing means, the specialist to print a predetermined amount of contracts at predetermined intervals in rising or falling markets.

51. The method as recited in claim 50 further comprises restricting, by the market-based computing means, the specialist to enter orders to buy on straight plus ticks or sell on straight minus ticks to add to the specialist's positions.

52. The method as recited in claim 51 further comprises permitting, by the market-based computing means, the specialist to trade for the specialist's own account by the specialist's purchasing on minus, zero minus, and zero plus ticks and selling on plus, zero, plus, and zero minus ticks.

53. The method as recited in claim 52 further comprises requiring, by the market-based computing means, the specialist's orders to compete with traders and brokerage firms according to time of entry and price.

54. The method as recited in claim 53 further comprises matching automatically by the market-based computing means marketable orders and offering the specialist a quantity of option contracts to buy or sell at all possible price levels within predetermined trading parameters.

55. The method as recited in claim 54 further comprises permitting, by the market-based computing means, the specialist to chose the specialist's level of participation in the market.

56. The method as recited in claim 55 further comprises tracking, by the market-based computing means, the specialist's position and providing such position to the specialist only.

57. The method as recited in claim 56 further comprises adjusting automatically, by the market-based computing means, the position of the specialist's limit orders to maintain the specialist's standing when either the specialist's limit orders are entered to offset (i.e., liquidate or cover) a position, or fall behind all limit orders by traders and brokerage firms orders when the specialist's position has been offset.

58. The method as recited in claim 57 further comprises tracking, by the market-based computing means, the specialist's position and adjusting the standing of the specialists bids or offers once the specialist's position begins to offset thereby preventing the specialist from maintaining standing on the book so as to add to specialist's position.

59. The method as recited in claim 58 further comprises requiring, by the market-based computing means, the specialist to purchase a predetermined amount of contracts to maintain the depth of the market.

60. The method as recited in claim 59 further comprises requiring, by the market-based computing means, the specialist to guarantee the price range between two contiguous trading windows at twice the predetermined trading range to be traded in one of the windows.

61. The method as recited in claim 60 further comprises requiring, by the market-based computing means, that marketable imbalances disappear from the window when the market gets down to a price where it can no longer sell any lower due to a limit, or when the market moves high enough that the imbalance can pay no higher, due to a limit.

62. The method as recited in claim 37 further comprises closing, by the market-based computing means, the market on the last business day of a week and after the close of the major markets (e.g., NYSE, AMEX).

63. The method as recited in claim 61 further comprises closing, by the market-based computing means, the market on the last business day of a week and after the close of the major markets (e.g., NYSE, AMEX).

64. The method as recited in claim 36 wherein the opening period of the window is for approximately twenty seconds.

65. The method as recited in claim 43 wherein the opening of the window is for approximately twenty seconds.

66. The method as recited in claim 65 wherein the making of the window accessible exclusively to the specialist is for approximately the first five seconds of the next window, and discreetly collecting new orders while the specialist is provided with the capability of selecting the execution prices for the previous window.

67. The method as recited in claim 37 further comprising providing, by the market-based computer means, an electronic book through which the windows are displayed.

68. The method as recited in claim 67 further comprises confirming predetermined data specific to a trader's account by communicating the data from the electronic book to the trader's computing means.

69. The method as recited in claim 68 further comprises providing a database for storing data;

70. The method as recited in claim 60 further comprising providing by the market-based computer means an electronic book through which the windows are displayed.

71. The method as recited in claim 69 further comprises confirming predetermined data specific to a trader's account by communicating the data from the electronic book to the trader's computing means.

72. The method as recited in claim 71 further comprises providing a database for storing data.

73. The method as recited in claim 69 further comprises confirming predetermined data specific to a trader's account by communicating the data from the electronic book to the trader's computing means.

74. The method as recited in claim 37 further comprises linking the market-based computer, through a global electronic network, access to the windows to a specialist, traders, and brokerage agencies computer means.

75. The method as recited in claim 60 further comprises linking the market-based computer, through a global electronic network, access to the windows to a specialist, traders, and brokerage agencies.

76. A method of security trading of the type using computers linked in a global network, such as the Internet comprising:
a) providing a market-based computer;
b) linking, by means of the global network, the market-based computer to others who have computers;
c) providing predetermined portions of the data as a function of the roll played by those linking to the market-based computer; and
d) limiting access to the entire data by means of recipient-specific access codes.

77. A method of security trading as recited in claim 76, further comprising displaying the actual amount of securities and the bid and asked for such securities (i.e., “the trading data”) by the market-based computer and providing the trading data to all those linked to the market based computer.

78. A method of security trading as recited in claim 77, further comprising providing each brokerage firm registered to trade with the market-based computer a brokerage-firm-specific access code; communicating between the market-based computer and the brokerage firm data specific to that brokerage firm.

79. A method of security trading as recited in claim 78, further comprising providing such specific data between the brokerage firm and the market-based computer as order entries and order cancellations and identification of accounts of specific traders who trade through the brokerage firm; and providing, by the market-based computer to the specific brokerage firm, data, including data relevant to receipt and executions of orders and status of traders' accounts who trade through that specific brokerage firm.

80. A method of security trading as recited in claim 77, further comprises communicating by the market-based computer to linked traders by a first trader-specific limited access code.

81. A method of security trading as recited in claim 80, further comprises linking between each trader to the brokerage firm maintaining the trader's account; and transmitting data between the trader and the brokerage firm by a second trader-brokerage-firm specific limited access code.

82. A method of security trading as recited in claim 81, further comprises the step of providing data by the to the trader brokerage firm includes providing data including order entries and order cancellation.

83. A method of security trading as recited in claim 82, further comprises the step of providing data by the brokerage firm to the trader including confirmation of execution of orders, trading account balances.

84. A method of security trading as recited in claim 77, further comprises linking the market-based computer to each trader for communication by the market-based computer to the trader by a trader-specific limited access code.

85. A method of security trading as recited in claim 84, further comprises the step of communicating data to each trader includes transmitting execution reports, cancellation confirmations, contracts ahead and orders and cancellations of the trader entered by the trader's brokerage firm in the market-based computer.

86. A method of security trading as recited in claim 76, further comprises providing means for entering orders directly into the market-based computer at the trading floor of an established exchange.

87. A method of security trading as recited in claim 86, further comprises the step of providing means for entering orders includes electronic data entry devices linked to the market-based computer.

88. A method of security trading as recited in claim 77, further comprises providing specific data to market disseminating media at predetermined intervals.

89. A method of security trading as recited in claim 88, further comprises the step of providing data to media, includes updating such data at 20 second intervals.

90. A method of security trading as recited in claim 77, further comprises linking the market-based computer to a specialist by a specialist-specific limited access code.

91. A method of security trading as recited in claim 90, further comprises the step providing exclusive access to the market-based computer to the specialist for predetermined limited times to communicate therebetween data including the specialist's placement of orders and cancellations and the confirmations thereof.
